(19) United States
(12) Patent Application Publication
(10) Pub. No.: US 2016/0248284 A1
(43) Pub. Date: Aug. 25, 2016

(54) Permanent magnet embedded rotor of BLDC motor

(71) Applicant: RENUN MECHANICAL & ELECTRIC CO., LTD., Zhuji City, Zhejiang (CN)

(72) Inventors: Kewei Wang, Zhuji, Zhejiang (CN); Ruiguang Wen, Zhuji, Zhejiang (CN)

(21) Appl. No.: 14/430,913

(22) PCT Filed: Mar. 10, 2014
(86) PCT No.: PCT/CN2014/073136

§ 371 Date: Mar. 25, 2015

(30) Foreign Application Priority Data
Feb. 27, 2014 (CN) 201410068613.9

(51) Int. Cl. H02K 1/27; H02K 1/32; H02K 21/14

(52) U.S. Cl. CPC H02K 1/276; H02K 21/14; H02K 1/32

(57) ABSTRACT

A permanent magnet embedded rotor of BLDC motor, comprises: a rotor core (A), which is in a shape of cylinder and formed by stacked rotor sheets, having p pairs of permanent magnet grooves (C) which are bar-shaped and 2p heat-radiating through-holes (B); wherein the p pairs of permanent magnet grooves (C) and the 2p heat-radiating through-holes (B) are all provided inside the rotor core (A) in a direction of an center axle thereof, and evenly spaced around the center axle of the rotor core (A); each of the heat-radiating through-holes (B) is provided between two permanent magnet grooves (C); and p is an integer no less than 1; and p pairs of permanent magnets (D) which are bar-shaped, fixedly provided in the permanent magnet grooves (C), wherein each of the permanent magnets (D) has a trapezoid cross section, and p is an integer no less than 1.

### CROSS REFERENCE OF RELATED APPLICATION

This is a U.S. National Stage under 35 U.S.C 371 of the International Application PCT/CN2014/073136, filed Mar. 10, 2014, which claims priority under 35 U.S.C. 119(a-d) to CN 201410068613.9, filed Feb. 27, 2014.

### BACKGROUND OF THE PRESENT INVENTION

1. Field of Invention

The present invention relates to a rotor of BLDC motor, and more particularly to a permanent magnet embedded rotor of BLDC motor.

2. Description of Related Arts

In order to reduce the magnetic flux leakage coefficient and increase the utilization of the permanent magnetic materials, the conventional permanent magnetic BLDC usually comprises the magnetic shielding means, i.e., providing the magnetic shielding air gaps at the two ends of the embedded permanent magnet.

The Chinese patent application “Rotor sheet of permanent magnet embedded motor and rotor of permanent magnet embedded motor” (Application Number 201210419454.3) disclosed rotor sheets of permanent magnet embedded motor and a rotor of permanent magnet embedded motor. The rotor of permanent magnet embedded motor comprises: a sheet body, comprising an inner sheet which is round in shape, wherein a plurality of notches are evenly spaced on an edge of the inner sheet in a direction of circumference, and a plurality of outer sheets matching the notches. Gaps are formed between the outer sheets and the inner sheet for fixing permanent magnets. The permanent magnets are put in the gaps formed by the notches of the inner sheet and the outer sheet, i.e., permanent magnet grooves, so as to limit moving of the permanent magnets.

The Chinese patent application “Unequal rotor sheet of permanent magnet motor with air gaps” (Application Number 201210074091.4) disclosed an unequal rotor sheet of permanent magnet motor with air gaps, which is assembled by a plurality of sector-shaped rotor sheets, wherein the sector-shaped rotor sheet has a permanent magnet groove and magnetic shielding bridges provided inside an outer arc thereof, and a locating hole provided on an inner arc thereof. The outer arcs of the sector-shaped rotor sheets which form a same rotor sheet have different circle centers. The outer arc and the inner arc of each sector-shaped rotor sheet also have different circle centers.

The Chinese patent application “Permanent magnet rotor and its manufacturing method” (Application Number 01121704.9, Publication Number CN1201463C) disclosed a permanent magnet rotor with a rotor core comprising permanent magnets embedded therein, wherein the permanent magnet rotor comprises slits in which the permanent magnets are embedded, and bridging parts provided at the internal side of the longitudinal ends, near the longitudinal middle portion, of the slits; the bridging parts respectively connect the radially outer portions to the radially inner portions, relative to each slit, of the rotor core; and the longitudinal ends of the slits are provided at the outer circular surface of the rotor core.

The Chinese patent application “Embedded sine-profile permanent magnet motor rotor” (Application Number 201210316633.4, Publication Number CN102857000A) disclosed an embedded sine-profile permanent motor rotor, wherein a plurality of consecutively connected arc protrusions are radially provided on the surface of the rotor; the rotor is separated into a plurality of equal areas by the ligature of the rotor axis and the cross point of each two adjacent protrusions; the two grooves in the inversely splayed shape are provided in each area; and the permanent magnets are inserted into the grooves.

In the conventional permanent magnet embedded rotor, the magnetic shielding air gap ω and the sheet margin b cause the magnetic circuit mutation, as shown in FIGS. 1-2, which further causes following two problems.

Firstly, the superficial magnetism waveform of each magnetic pole is saddle-shaped which is shown in FIG. 3. The peak values and the valley values have relatively large difference, which causes the torque fluctuation and affects the smooth operation of the motor.

Secondly, the two convex waveforms, as shown in FIG. 5, emerge at the boundary between the two magnetic poles. The two convex waveforms caused by the structural defect of the magnetic circuit will cause Hall signal jitters, drive waveform distortion, and further increase the fluctuation of the outputted motor torque and motor loss. Therefore, it is necessary to improve the permanent magnet embedded rotor.

### SUMMARY OF THE PRESENT INVENTION

An object of the present invention is to provide a permanent magnet embedded rotor of BLDC motor, wherein reasonable layout of rotor and permanent magnets having trapezoid cross sections are adopted, magnetic flux directions of the permanent magnets inside the rotor are guided to improve partial magnetic flux directions and eliminate magnetic density mutations, and further significantly improve superficial magnetism curves of the rotor.

Another object of the present invention is to provide a permanent magnet embedded rotor of BLDC motor, wherein heat-radiating through-holes are provided between permanent magnets, to improving heat-radiating performance of the rotor and save materials.

Accordingly, in order to accomplish the above objects, the present invention provides a permanent magnet embedded rotor of BLDC motor, comprising:

a rotor core A, which is in a shape of cylinder and formed by stacked rotor sheets, having p pairs of permanent magnet grooves C which are bar-shaped and 2p heat-radiating through-holes B; wherein the p pairs of permanent magnet grooves C and the 2p heat-radiating through-holes B are all provided inside the rotor core A in a direction of an center axle thereof, and evenly spaced around the center axle of the rotor core A; each of the heat-radiating through-holes B is provided between two permanent magnet grooves C; and p is an integer no less than 1; and

p pairs of permanent magnets D which are bar-shaped fixedly provided in the permanent magnet grooves C, wherein each of the permanent magnets D has a trapezoid cross section, and p is an integer no less than 1.

Preferably, the permanent magnet groove C matches the permanent magnet D completely.

Preferably, each of the heat-radiating through-holes B has a sector-shaped cross section, and two radiuses of the sector are respectively opposite to legs of two adjacent trapezoids. A saturation of partial magnetic density is controlled to control a magnetic flux leakage coefficient of each magnetic pole, and to increase superficial magnetism of each magnetic pole of the rotor and utilization of the permanent magnets.

Preferably, a distance H between the leg of the trapezoid and the radius of the sector which are opposite to each other is 0.5-3 mm.

Preferably, the two radiuses of the sector are respectively parallel to the legs of the two adjacent trapezoids.

Preferably, compared to a central angle of the sector, an arc of the sector is closer to a periphery of the rotor core A. A distance I between the arc of the sector and the periphery of the rotor core A is 0.5-3 mm. the saturation of partial magnetic density is controlled to reduce magnetic flux leakage between the magnetic poles.

Preferably, an angle between two legs of each of the trapezoids is 5°-20°.

Preferably, the rotor core A is manufactured integrally.

Alternatively, the cross section of the permanent magnet D is arc-shaped.

In the embodiment of the present invention, p=2. Alternatively, p=1, 3, 4, or 5.

The benefits of the present invention are as follows.

Firstly, the permanent magnet embedded rotor in the present invention adopts reasonable layout of rotor and permanent magnets having cross sections of trapezoid, in order to improve a saddle shape of each magnetic pole, flatten waveforms, and efficiently suppress two superficial magnetism convex waves emerging at a boundary between two magnetic poles. Thus, Hall signal jitter phenomenon appearing when commutating has been significantly improved, distortion of waveforms outputted by a driving circuit is avoided, and fluctuations of output torque are reduced, in such a manner that the motor operates more smoothly and more efficiently with less shake.

Secondly, the permanent magnet embedded rotor in the present invention improves the average superficial magnetism value corresponding to each magnetic pole of the rotor over 50%, compared with prior arts. Meanwhile, the superficial magnetic waveform corresponding to each magnetic pole is obviously improved, so as to improve the integral performance and the power density of the motor.

Thirdly, the permanent magnet embedded rotor of BLDC motor in the present invention has advantages of good heat-radiating performance and saving materials. When the BLDC motor is at high speed, the BLDC motor obtains better effects of dynamic balance and less wind noise, so as to accomplish lower cost and better performance.

These and other objectives, features, and advantages of the present invention will become apparent from the following detailed description, the accompanying drawings, and the appended claims.

### BRIEF DESCRIPTION OF THE DRAWINGS

FIG. 1 is a sketch view of a structure of conventional permanent magnet embedded rotor.

FIG. 2 is a partially enlarged view of A in FIG. 1.

FIG. 3 is a distribution diagram of superficial magnetism of the conventional permanent magnet embedded rotor.

FIG. 4 is a distribution diagram of superficial magnetism of a permanent magnet embedded rotor according to a preferred embodiment of the present invention.

FIG. 5 is a partially enlarged view of FIG. 3, showing two convex waveforms between two magnetic poles.

FIG. 6 is a partially enlarged view of FIG. 4, showing that the two convex waveforms between the two magnetic poles are suppressed.

FIG. 7 is a partially enlarged view of FIG. 3, showing superficial magnetism distribution of a magnetic pole.

FIG. 8 is a partially enlarged view of FIG. 4, showing the superficial magnetism distribution of the magnetic pole.

FIG. 9 is a sectional view of a permanent magnet according to the preferred embodiment of the present invention.

FIG. 10 is a sectional view of a rotor core according to the preferred embodiment of the present invention.

FIG. 11 is a sectional view of the permanent magnet embedded rotor according to the preferred embodiment of the present invention.

### ELEMENTS

A, rotor core;

B, heat-radiating through-hole;

C, permanent magnet groove;

D, permanent magnet.

### DETAILED DESCRIPTION OF THE PREFERRED EMBODIMENT

In order to understand the above technical solution of the present invention better, the technical solution is described in detail according to drawings and preferred embodiments as follows.

Referring to FIGS. 10-11, a permanent magnet embedded rotor of BLDC motor comprises:

a rotor core A, which is in a shape of cylinder and formed by stacked rotor sheet, having p pairs of permanent magnet grooves C which are bar-shaped and 2p heat-radiating through-holes B; wherein the p pairs of permanent magnet grooves C and the 2p heat-radiating through-holes B are all provided inside the rotor core A in a direction of an center axle thereof, and evenly spaced around the center axle of the rotor core A; each of the heat-radiating through-holes B is provided between two permanent magnet grooves C; and p is an integer no less than 1; and

p pairs of permanent magnets D which are bar-shaped, fixedly provided in the permanent magnet grooves C, wherein each of the permanent magnets D has a trapezoid cross section, and p is an integer no less than 1.

Preferably, the permanent magnet groove C matches the permanent magnet D completely.

Preferably, each of the heat-radiating through-holes B has a sector-shaped cross section, and two radiuses of the sector are respectively opposite to legs of two adjacent trapezoids. A saturation of partial magnetic density is controlled to control a magnetic flux leakage coefficient of each magnetic pole, and to increase superficial magnetism of each magnetic pole of the rotor and utilization of the permanent magnets.

Preferably, a distance H between the leg of the trapezoid and the radius of the sector which are opposite to each other is 0.5-3 mm.

Preferably, the two radiuses of the sector are respectively parallel to the legs of the two adjacent trapezoids.

Preferably, compared to a central angle of the sector, an arc of the sector is closer to a periphery of the rotor core A. A distance I between the arc of the sector and the periphery of the rotor core A is 0.5-3 mm. the saturation of partial magnetic density is controlled to reduce magnetic flux leakage between the magnetic poles.

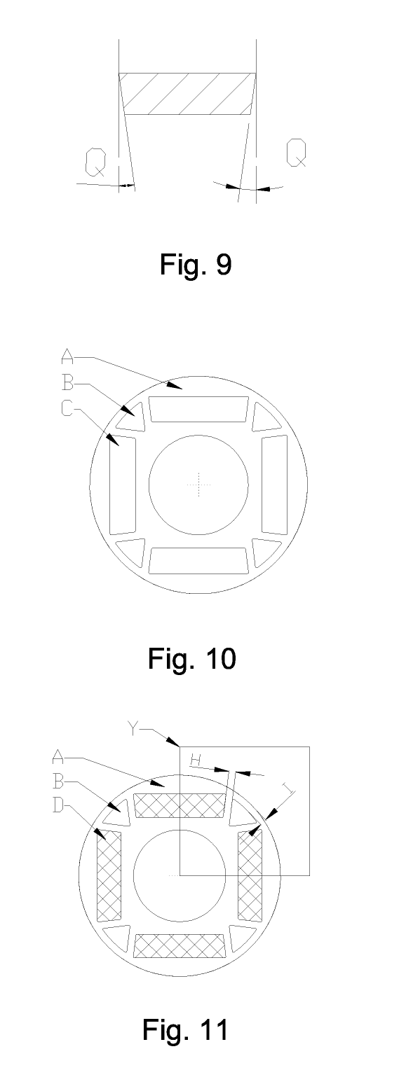

Referring to FIG. 9, preferably, an angle between two legs of each of the trapezoids is 5°-20°.

Preferably, the rotor core A is manufactured integrally.

Alternatively, the cross section of the permanent magnet D is arc-shaped.

In the present invention, reasonable layout of rotor and permanent magnets having trapezoid cross sections are adopted. Magnetic flux directions of the permanent magnets inside the rotor are guided to improve partial magnetic flux directions and eliminate magnetic density mutations, and further significantly improve superficial magnetism curves of the rotor.

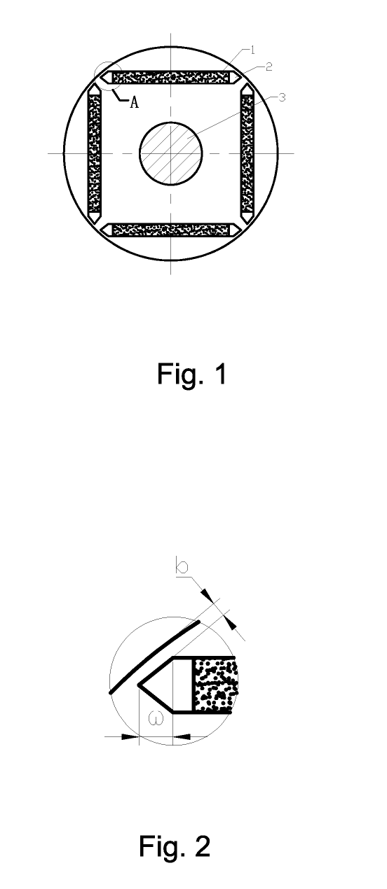

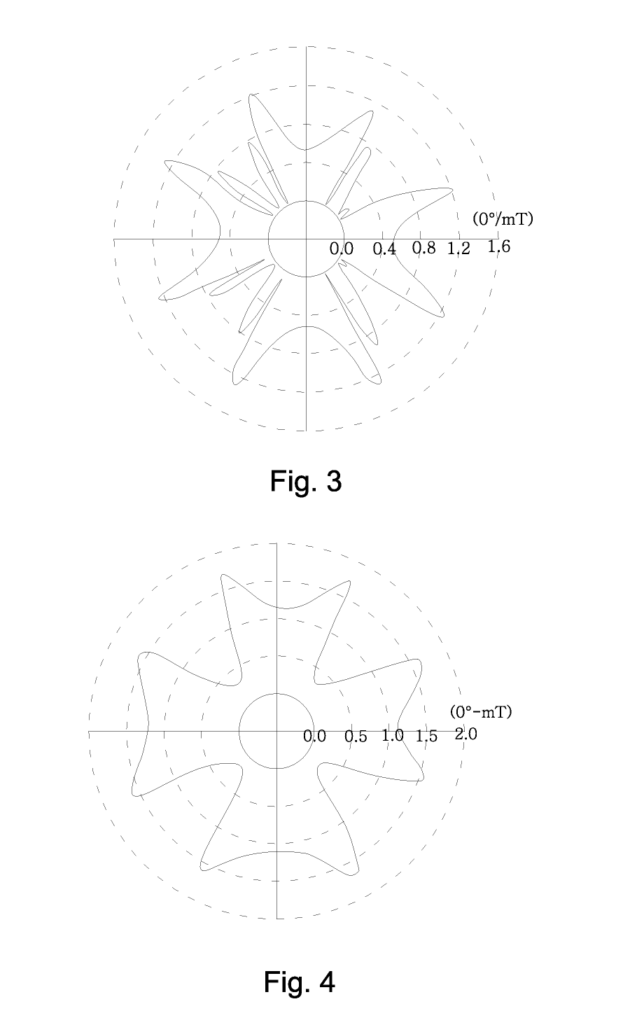

Referring to FIGS. 1-2, a conventional permanent magnet embedded rotor comprises magnetic shielding air gaps provided at two sides of a permanent magnet. Superficial magnetism of the conventional permanent magnet embedded rotor is measured, and a distribution diagram of the superficial magnetism is shown in FIG. 3.

Superficial magnetism of the permanent magnet embedded rotor in the present invention is measured, and a distribution diagram of the superficial magnetism is shown in FIG. 4.

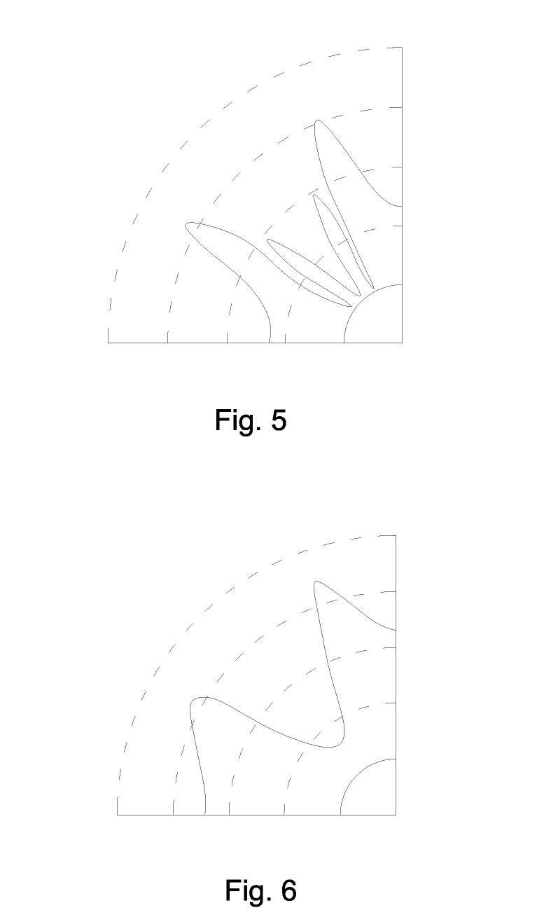

As shown in FIGS. 5-6, superficial magnetism curve of the conventional permanent magnet embedded rotor has a plurality of convex waveforms, and superficial magnetism curve of the permanent magnet embedded rotor in the present invention has no convex waveform, which means that the permanent magnet embedded rotor in the present invention is able to suppress convex waveforms efficiently, so as to improve Hall signal jitter phenomenon appearing when commutating, avoid distortion of waveforms outputted by a driving circuit, and reduce fluctuations of output torque. Thus, the motor operates smoothly and operating efficiency of the motor is increased.

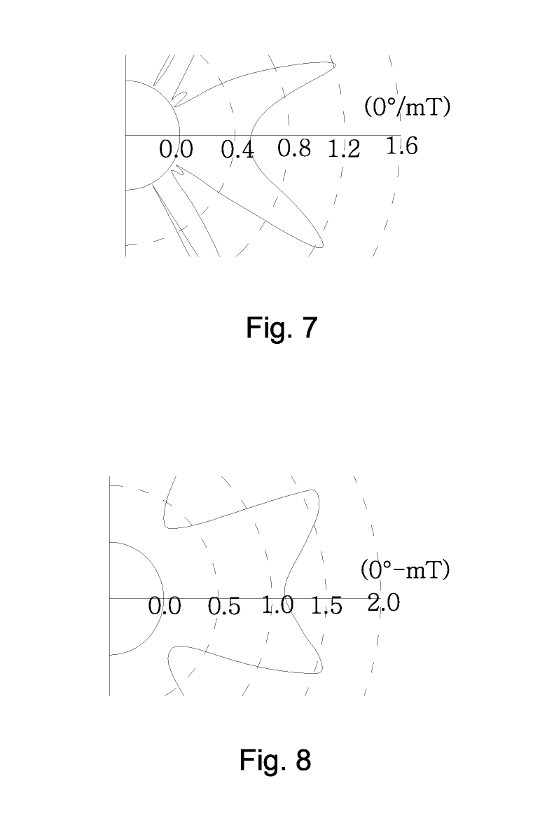

Referring to FIGS. 7-8, despite of identical permanent magnets with the superficial magnetism of 200 mT, an average value of the superficial magnetism of each magnetic pole in the conventional permanent magnet embedded rotor is 90 mT, whereas an average value of the superficial magnetism of each magnetic pole in the permanent magnet embedded rotor of the present invention is 140 mT. Thus, compared with the conventional permanent magnet embedded rotor, the average value of the superficial magnetism of each magnetic pole in the permanent magnet embedded rotor of the present invention is increased more than 50%. Meanwhile, superficial magnetism waveform of each magnetic pole in the present invention has an obviously improved saddle shape, so as to obtain a better integral performance and a higher power density of the motor.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A permanent magnet embedded rotor of BLDC motor, comprising:
a rotor core (A), which is in a shape of cylinder and formed by stacked rotor sheets, having p pairs of permanent magnet grooves (C) which are bar-shaped and 2p heat-radiating through-holes (B); wherein said p pairs of permanent magnet grooves (C) and said 2p heat-radiating through-holes (B) are all provided inside said rotor core (A) in a direction of an center axle thereof, and evenly spaced around said center axle of said rotor core (A); each of said heat-radiating through-holes (B) is provided between two permanent magnet grooves (C); and p is an integer no less than 1; and
p pairs of permanent magnets (D) which are bar-shaped, fixedly provided in said permanent magnet grooves (C), wherein each of said permanent magnets (D) has a trapezoid cross section, and p is an integer no less than 1.

2. The permanent magnet embedded rotor, as recited in claim 1, wherein said permanent magnet groove (C) matches said permanent magnet (D) completely.

3. The permanent magnet embedded rotor, as recited in claim 1, wherein each of said heat-radiating through-holes (B) has a sector-shaped cross section, and two radiuses of said sector are respectively opposite to legs of two adjacent trapezoids.

4. The permanent magnet embedded rotor, as recited in claim 3, wherein a distance H between said leg of said trapezoid and said radius of said sector which are opposite to each other is 0.5-3 mm.

5. The permanent magnet embedded rotor, as recited in claim 3, wherein said two radiuses of said sector are respectively parallel to said legs of said two adjacent trapezoids.

6. The permanent magnet embedded rotor, as recited in claim 3, wherein compared to a central angle of the sector, an arc of said sector is closer to a periphery of said rotor core (A), and a distance I between said arc of said sector and said periphery of said rotor core (A) is 0.5-3 mm.

7. The permanent magnet embedded rotor, as recited in claim 1, wherein an angle between two legs of each of said trapezoids is 5°-20°.
